(19) United States
(12) Patent Application Publication
(10) Pub. No.: US 2016/0160887 A1
(43) Pub. Date: Jun. 9, 2016

(54) Systems and Methods for Rotor Axial Force Balancing

(71) Applicant: Energy Recovery, Inc., San Leandro, CA (US)

(72) Inventor: David Deloyd Anderson, Castro Valley, CA (US)

(21) Appl. No.: 14/958,723

(22) Filed: Dec. 3, 2015

Related U.S. Application Data
(60) Provisional application No. 62/088,369, filed on Dec. 5, 2014.

(51) Int. Cl. F15B 15/06

(52) U.S. Cl. CPC F15B 15/06

(57) ABSTRACT

A system includes a rotary isobaric pressure exchanger (IPX) including a rotor. The rotor includes a first axial end face and a second axial end face. The rotary IPX also includes a first endplate including a first axial surface disposed adjacent to the first axial end face of the rotor. The first endplate also includes a first low pressure fluid port and first high pressure fluid port. Additionally, the first endplate includes a channel formed in the first axial surface and extending from the first low pressure fluid port. Further, the first endplate includes a first low pressure sink formed in the first axial surface and extending from the first channel. The first channel is configured to route low pressure fluid from the first low pressure fluid port to the first low pressure sink.

### CROSS-REFERENCE TO RELATED APPLICATION

This application claims priority to and benefit of U.S. Provisional Patent Application No. 62/088,369, entitled “Systems and Methods for Rotor Axial Force Balancing,” filed Dec. 5, 2014, which is herein incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The subject matter disclosed herein relates to rotating equipment, and, more particularly, to systems and methods for an axial bearing system for use with rotating equipment.

Fluid handling equipment, such as rotary pumps, pressure exchangers, and hydraulic energy transfer systems, may be susceptible to loss in efficiency, loss in performance, wear, and sometimes breakage over time. As a result, the equipment must be taken off line for inspection, repair, and/or replacement. Unfortunately, the downtime of this equipment may be labor intensive and costly for the particular plant, facility, or work site. In certain instances, the fluid handling equipment may be susceptible to misalignment, imbalances, or other irregularities, which may increase wear and other problems, and also cause unexpected downtime. This equipment downtime is particularly problematic for continuous operations. Therefore, a need exists to increase the reliability and longevity of fluid handling equipment.

In certain applications, axial pressure imbalances (e.g., the difference in average pressure between two axial faces) may exert a substantial net force on rotating components of the fluid handling equipment. Axial forces may also arise due to the weight of the rotating components. In some situations, imbalanced pressure loading on the rotating components may cause the rotating components to axially translate, which may result in axial contact between the rotating components and stationary components of the fluid handling equipment. Unfortunately, such axial contact may result in stalling of the fluid handling equipment and wear and/or stress on the fluid handling equipment, and may reduce the life of the fluid handling equipment and result in a loss of efficiency.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic diagram of a hydraulic fracturing system with a hydraulic energy transfer system;

FIG. 2 is an exploded perspective view of an embodiment of the hydraulic energy transfer system of FIG. 1, illustrated as a rotary isobaric pressure exchanger (IPX) system;

FIG. 3 is an exploded perspective view of an embodiment of a rotary IPX in a first operating position;

FIG. 4 is an exploded perspective view of an embodiment of a rotary IPX in a second operating position;

FIG. 5 is an exploded perspective view of an embodiment of a rotary IPX in a third operating position;

FIG. 6 is an exploded perspective view of an embodiment of a rotary IPX in a fourth operating position;

FIG. 7 is a cross-sectional view of an embodiment of the hydraulic energy transfer system of FIG. 1, illustrating the hydraulic energy transfer system with a hydrostatic bearing system;

FIG. 8 is a cross-sectional axial view taken along line 8-8 of FIG. 7, illustrating an embodiment of an endplate of the hydraulic energy transfer system of FIG. 7;

FIG. 9 is a cross-sectional view of an embodiment of the hydraulic energy transfer system, illustrating an axial translation of a rotor of the hydraulic energy transfer system;

FIG. 10 is a schematic diagram of an embodiment of an endplate of the hydraulic energy transfer system of FIG. 7, illustrating a sink channel and a low pressure sink;

FIG. 11 is a schematic diagram of an embodiment of a first endplate of the hydraulic energy transfer system of FIG. 7, having a sink channel and a low pressure sink, and a second endplate of the hydraulic energy transfer system of FIG. 7, having a first sink channel, a second sink channel, and a partial low pressure sink loop;

FIG. 12 is a schematic diagram of an embodiment of a first endplate of the hydraulic energy transfer system of FIG. 7, having a sink channel and a low pressure sink, and a second endplate of the hydraulic energy transfer system of FIG. 7, having a sink channel, a partial low pressure sink loop, and two sink endpoints; and

FIG. 13 is a schematic diagram of an embodiment of a first endplate of the hydraulic energy transfer system of FIG. 7, having a sink channel and a low pressure sink with a first width, and a second endplate of the hydraulic energy transfer system of FIG. 7, having a sink channel and a low pressure sink loop with a second width.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Well completion operations in the oil and gas industry often involve hydraulic fracturing (often referred to as fracking or fracing) to increase the release of oil and gas in rock formations. Hydraulic fracturing involves pumping a fluid (e.g., frac fluid) containing a combination of water, chemicals, and proppant (e.g., sand, ceramics) into a well at high-pressures. The high-pressures of the fluid increases crack size and propagation through the rock formation releasing more oil and gas, while the proppant prevents the cracks from closing once the fluid is depressurized. Fracturing operations use a variety of rotating equipment, such as a hydraulic energy transfer system, to handle a variety of fluids.

As discussed in detail below, the embodiments disclosed herein generally relate to systems and methods for rotating systems that may be utilized in various industrial applications. For example, the embodiments disclosed herein may generally relate to rotating systems utilized within a hydraulic fracturing system. As noted above, hydraulic fracturing systems and operations use a variety of rotating equipment, such as a hydraulic energy transfer system, to handle a variety of fluids. In certain situations, the hydraulic energy transfer system may include a bearing system, such as a hydrostatic bearing system, to facilitate the rotation of the rotating components of the hydraulic energy transfer system by providing a bearing fluid (e.g., a lubricating fluid such as oil, grease, and/or liquid/powder mixtures with powder, graphite, PTFE, molybdenum disulfide, tungsten disulfide, etc.). In particular, the bearing fluid may be routed through an outer surface of a sleeve of the hydraulic energy transfer system and into an inner surface of the sleeve of the hydraulic energy transfer system via a pressure differential or a pressure gradient. For example, the bearing fluid may be provided at a high-pressure from the outer surface of the sleeve and the bearing fluid may travel through an aperture (e.g., a bearing inlet) through the sleeve into a radial bearing region (e.g., a radial plenum) of the hydraulic energy transfer system. The radial bearing region may be disposed between the inner surface of the sleeve and the outer surface (e.g., outer lateral surface) of a rotor of the hydraulic energy transfer system. In addition, the bearing fluid may move through the radial bearing region to a lower pressure region via the pressure gradients present in the hydraulic energy transfer system. In particular, the bearing system may be specifically designed with and/or may include a pressure differential system (or lubricant suction-driven flow system) to induce flow of the bearing fluid along the various bearing surfaces. The bearing system also may be designed to provide a constant or differential flow and distribution of the bearing fluid, depending on areas of high or low wear.

However, in certain situations involving high pressures or other challenging applications, axial force imbalances (e.g., the difference in average pressure between two axial faces) may exert a substantial axial net force on rotating components of the hydraulic energy transfer system. Axial force imbalances may also arise due to the weight of the rotating components. For example, imbalanced pressure loading on the rotating components may cause the rotating components to axially translate, which may result in axial contact between the rotating components and stationary components of the hydraulic energy transfer system. Unfortunately, the axial contact may result in stalling of the hydraulic energy transfer system (e.g., stop rotation of a rotor) and wear and/or stress on the hydraulic energy transfer system, which may reduce the life of the hydraulic energy transfer system and result in a loss of efficiency. Accordingly, the embodiments described herein provide systems and methods for a bearing system that includes features to compensate for, correct, adjust and/or balance net axial forces on the rotating components of the hydraulic energy transfer system by increasing load bearing capacity and/or increasing bearing stiffness (e.g., a bearing system with a higher bearing stiffness may have a clearance that changes less under load as compared to a bearing system with a lower bearing stiffness) to facilitate the rotation of the rotating components. In some embodiments, the bearing system may reduce, resist, or avoid axial translation of the rotor.

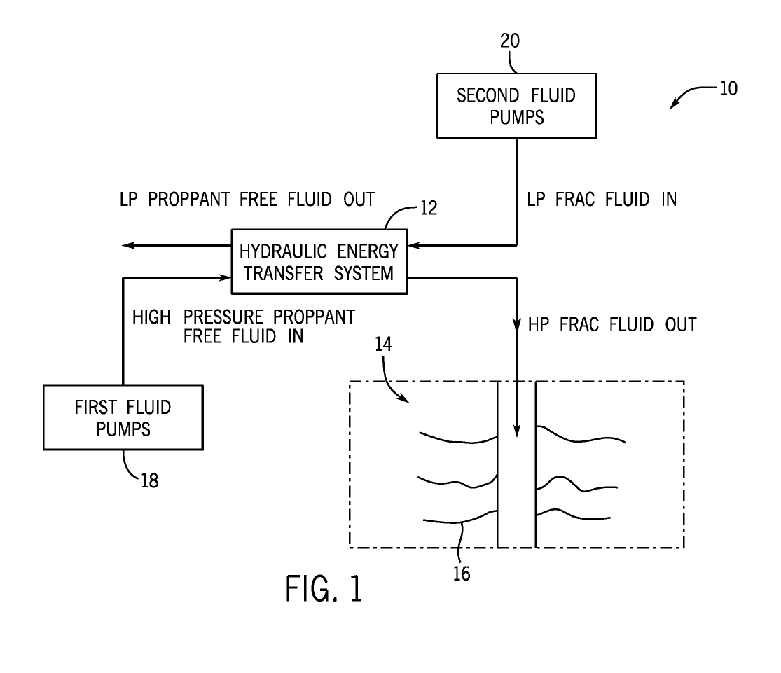

With the foregoing in mind, FIG. 1 is a schematic diagram of an embodiment of a hydraulic fracturing system 10 (e.g., fluid handling system, hydraulic protection system, hydraulic buffer system, or hydraulic isolation system) with a hydraulic energy transfer system 12. The hydraulic fracturing system 10 enables well completion operations to increase the release of oil and gas in rock formations. Specifically, the hydraulic fracturing system 10 pumps a proppant containing fluid (e.g., a frac fluid) containing a combination of water, chemicals, and proppant (e.g., sand, ceramics, etc.) into a well 14 at high pressures. The high pressures of the proppant containing fluid increases the size and propagation of cracks 16 through the rock formation, which releases more oil and gas, while the proppant prevents the cracks 16 from closing once the proppant containing fluid is depressurized. As illustrated, the hydraulic fracturing system 10 may include one or more first fluid pumps 18 and one or more second fluid pumps 20 coupled to the hydraulic energy transfer system 12. For example, the hydraulic energy transfer system 12 may include a hydraulic turbocharger, rotary isobaric pressure exchanger (IPX), reciprocating IPX, or any combination thereof. In addition, the hydraulic energy transfer system 12 may be disposed on a skid separate from the other components of the hydraulic fracturing system 10, which may be desirable in situations in which the hydraulic energy transfer system 12 is added to an existing hydraulic fracturing system 10.

In operation, the hydraulic energy transfer system 12 transfers pressures without any substantial mixing between a first fluid (e.g., proppant free fluid) pumped by the first fluid pumps 18 and a second fluid (e.g., proppant containing fluid or frac fluid) pumped by the second fluid pumps 20. In this manner, the hydraulic energy transfer system 12 blocks or limits wear on the first fluid pumps 18 (e.g., high-pressure pumps), while enabling the hydraulic fracturing system 10 to pump a high-pressure frac fluid into the well 14 to release oil and gas. In addition, because the hydraulic energy transfer system 12 is configured to be exposed to the first and second fluids, the hydraulic energy transfer system 12 may be made from materials resistant to corrosive and abrasive substances in either the first and second fluids. For example, the hydraulic energy transfer system 12 may be made out of ceramics (e.g., alumina, cermets, such as carbide, oxide, nitride, or boride hard phases) within a metal matrix (e.g., Co, Cr, Ni, or any combination thereof). In certain embodiments, the hydraulic energy transfer system 12 may be made out of tungsten carbide in a matrix of CoCr, Ni, NiCr, or Co.

While the illustrated embodiment relates to a hydraulic fracturing system 10 as one example application, the hydraulic energy transfer system 12 may be used with any suitable fluid handling system configured to utilize a high pressure fluid. For example, the hydraulic energy transfer system 12 may be used with desalination systems, urea production systems, ammonium nitrate production systems, urea ammonium nitrate (UAN) production systems, polyamide production systems, polyurethane production systems, phosphoric acid production systems, phosphate fertilizer production systems, calcium phosphate fertilizer production systems, oil refining systems, oil extraction systems, petrochemical systems, pharmaceutical systems, or any other systems configured to handle abrasive and/or corrosive fluids. Further, the first fluid may be a pressure exchange fluid or a clean fluid that is non-abrasive, non-corrosive, and/or substantially particulate free (e.g., proppant-free). For example, the first fluid may be water or a dielectric fluid (e.g., oil). In certain embodiments, the second fluid may be a fluid that is abrasive, corrosive, and/or particulate-laden (e.g., proppant-laden, a frac fluid). The first and second fluids may be multi-phase fluids such as gas/liquid flows, gas/solid particulate flows, liquid/solid particulate flows, gas/liquid/solid particulate flows, or any other multi-phase flow. For example, the multi-phase fluids may include sand, solid particles, powders, debris, ceramics, or any combination therefore. These fluids may also be non-Newtonian fluids (e.g., shear thinning fluid), highly viscous fluids, non-Newtonian fluids containing proppant, or highly viscous fluids containing proppant. Further, the first fluid may be at a first pressure between approximately 5,000 kPa to 25,000 kPa, 20,000 kPa to 50,000 kPa, 40,000 kPa to 75,000 kPa, 75,000 kPa to 100,000 kPa or greater than a second pressure of the second fluid.

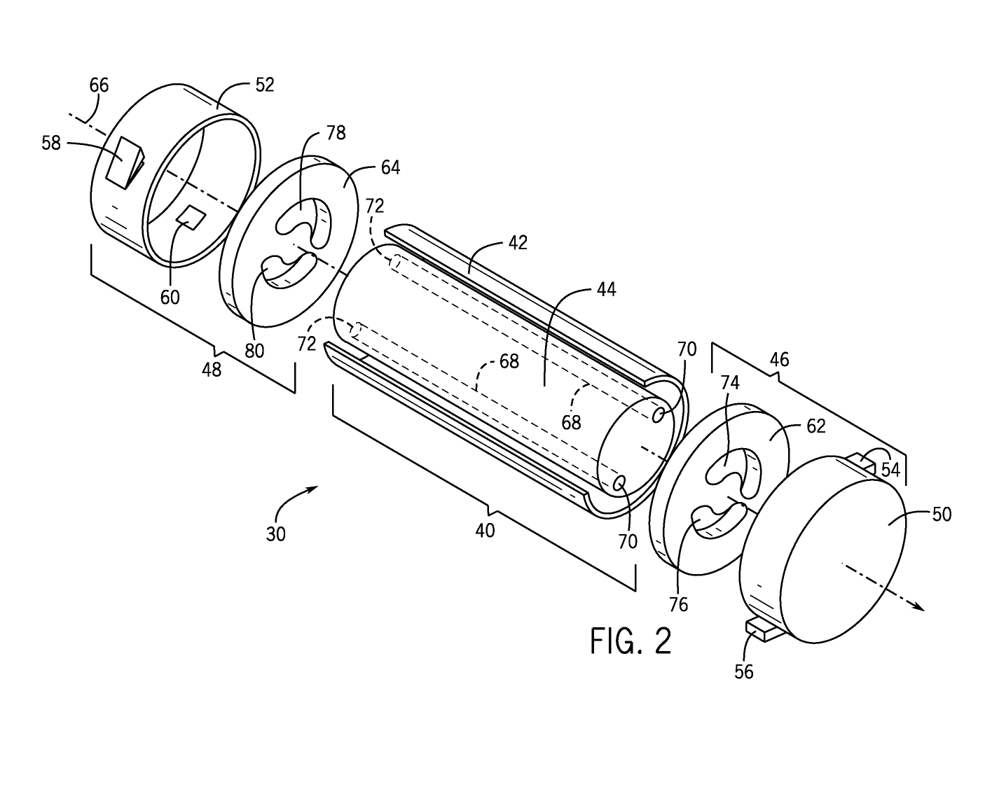

As noted above, in certain embodiments, the hydraulic energy transfer system 12 may include an IPX (e.g., a rotary IPX), which may be configured to receive the first fluid (e.g., proppant free fluid) from the one or more first fluid pumps 18 (e.g., high pressure pumps) and the second fluid (e.g., proppant containing fluid or frac fluid) from the one or more second fluid pumps 20. As used herein, the isobaric pressure exchanger (IPX) may be generally defined as a device that transfers fluid pressure between a high pressure inlet stream and a low pressure inlet stream at efficiencies in excess of approximately 50%, 60%, 70%, 80%, 90%, or greater without utilizing centrifugal technology. In this context, high pressure refers to pressures greater than the low pressure. For example, the high pressure may be 1.01 to 100, 1.05 to 50, 1.1 to 40, 1.2 to 30, 1.3 to 20, 1.4 to 10, or 1.5 to 5 times greater than the low pressure. The low pressure inlet stream of the IPX may be pressurized and exit the IPX at high pressure (e.g., at a pressure greater than that of the low pressure inlet stream), and the high pressure inlet stream may be depressurized and exit the IPX at low pressure (e.g., at a pressure less than that of the high pressure inlet stream). Additionally, the IPX may operate with the high pressure fluid directly applying a force to pressurize the low pressure fluid, with or without a fluid separator between the fluids. Examples of fluid separators that may be used with the IPX include, but are not limited to, pistons, bladders, diaphragms and the like. In certain embodiments, isobaric pressure exchangers may be rotary devices. Rotary isobaric pressure exchangers (IPXs), such as those manufactured by Energy Recovery, Inc. of San Leandro, CA, may not have any separate valves, since the effective valving action is accomplished internal to the device via the relative motion of a rotor with respect to endplates, as described in detail below with respect to FIGS. 2-6. Rotary IPXs may be designed to operate with internal pistons to isolate fluids and transfer pressure with relatively little mixing of the inlet fluid streams. Reciprocating IPXs may include a piston moving back and forth in a cylinder for transferring pressure between the fluid streams. Any IPX or plurality of IPXs may be used in the disclosed embodiments, such as, but not limited to, rotary IPXs, reciprocating IPXs, or any combination thereof.

FIG. 2 is an exploded view of an embodiment of a rotary IPX 30. In the illustrated embodiment, the rotary IPX 30 may include a generally cylindrical body portion 40 that includes a sleeve 42 and a rotor 44. The rotary IPX 30 may also include two end structures 46 and 48 that include manifolds 50 and 52, respectively. Manifold 50 includes inlet and outlet ports 54 and 56, and manifold 52 includes inlet and outlet ports 60 and 58. For example, inlet port 54 may receive a first fluid (e.g., proppant free fluid) at a high pressure and the outlet port 56 may be used to route the first fluid a low pressure away from the rotary IPX 30. Similarly, inlet port 60 may receive a second fluid (e.g., proppant containing fluid or frac fluid) and the outlet port 58 may be used to route the second fluid at high pressure away from the rotary IPX 30. The end structures 46 and 48 include generally flat endplates 62 and 64 (e.g., endcovers), respectively, disposed within the manifolds 50 and 52, respectively, and adapted for fluid sealing contact with the rotor 44.

The rotor 44 may be cylindrical and disposed in the sleeve 42 in a concentric arrangement, and is arranged for rotation about a longitudinal axis 66 of the rotor 44. The rotor 44 may have a plurality of channels 68 extending substantially longitudinally through the rotor 44 with openings 70 and 72 at each end arranged symmetrically about the longitudinal axis 66. The openings 70 and 72 of the rotor 44 are arranged for hydraulic communication with the endplates 62 and 64, and inlet and outlet apertures (e.g., ports) 74 and 76, and 78 and 80, in such a manner that during rotation they alternately hydraulically expose fluid at high pressure and fluid at low pressure to the respective manifolds 50 and 52. The inlet and outlet ports 54, 56, 58, and 60, of the manifolds 50 and 52 form at least one pair of ports for high pressure fluid in one end element 46 or 48, and at least one pair of ports for low pressure fluid in the opposite end element, 48 or 46. The endplates 62 and 64, and inlet and outlet apertures 74 and 76, and 78 and 80 are designed with perpendicular flow cross sections in the form of arcs or segments of a circle.

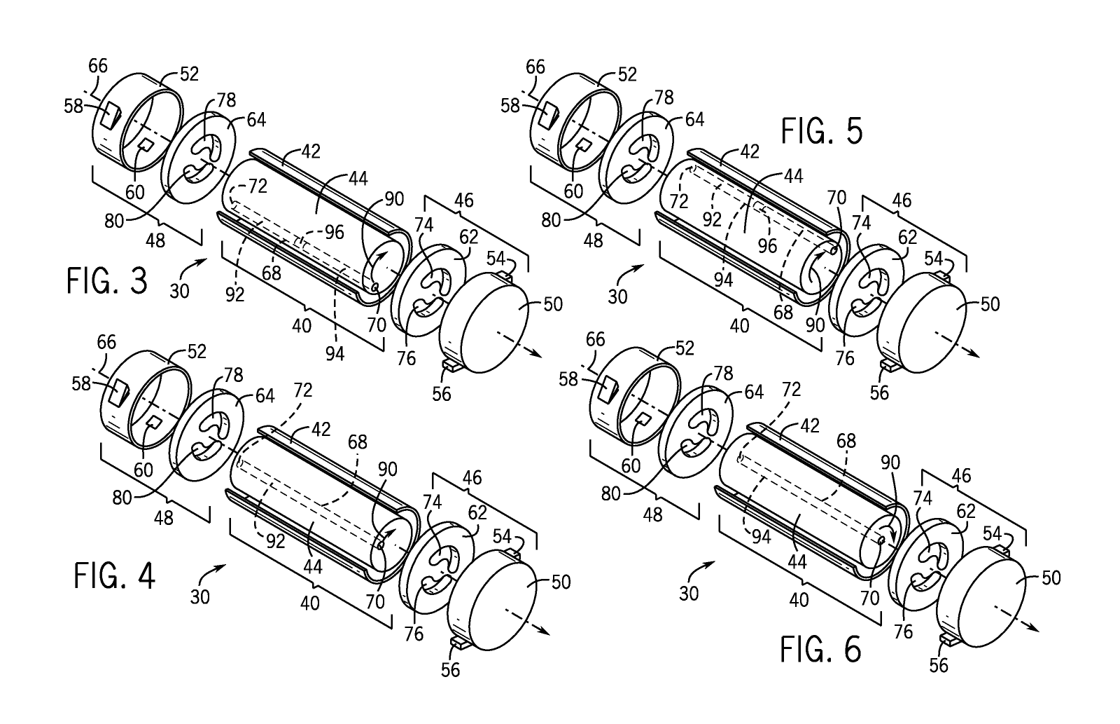

FIGS. 3-6 are exploded views of an embodiment of the rotary IPX 30 illustrating the sequence of positions of a single channel 68 in the rotor 44 as the channel 68 rotates through a complete cycle. It is noted that FIGS. 3-6 are simplifications of the rotary IPX 30 showing one channel 68, and the channel 68 is shown as having a circular cross-sectional shape. In other embodiments, the rotary IPX 30 may include a plurality of channels 68 (e.g., 2 to 100) with different cross-sectional shapes (e.g., circular, oval, square, rectangular, polygonal, etc.). Thus, FIGS. 3-6 are simplifications for purposes of illustration, and other embodiments of the rotary IPX 30 may have configurations different from that shown in FIGS. 3-6. As described in detail below, the rotary IPX 30 facilitates a hydraulic exchange of pressure between first and second fluids (e.g., proppant free fluid and proppant-laden fluid) by enabling the first and second fluids to momentarily contact each other within the rotor 44. In certain embodiments, this exchange happens at speeds that results in little mixing of the first and second fluids.

In FIG. 3, the channel opening 70 is in a first position. In the first position, the channel opening 70 is in hydraulic communication with the aperture 76 in endplate 62 and therefore with the manifold 50, while opposing channel opening 72 is in hydraulic communication with the aperture 80 in endplate 64 and by extension with the manifold 52. As will be discussed below, the rotor 44 may rotate in the clockwise direction indicated by arrow 90. In operation, low pressure second fluid 92 passes through endplate 64 and enters the channel 68, where it contacts first fluid 94 at a dynamic interface 96. The second fluid 92 then drives the first fluid 94 out of the channel 68, through the endplate 62, and out of the rotary IPX 30. However, because of the short duration of contact, there is minimal mixing between the first fluid 94 and the second fluid 92.

In FIG. 4, the channel 68 has rotated clockwise through an arc of approximately 90 degrees. In this position, the opening 72 is no longer in hydraulic communication with the apertures 78 and 80 of the endplate 64, and the opening 70 of the channel 68 is no longer in hydraulic communication with the apertures 74 and 76 of the endplate 62. Accordingly, the low pressure second fluid 92 is temporarily contained within the channel 68.

In FIG. 5, the channel 68 has rotated through approximately 180 degrees of arc from the position shown in FIG. 3. The opening 72 is now in hydraulic communication with the aperture 78 in the endplate 64, and the opening 70 of the channel 68 is now in hydraulic communication with the aperture 74 of the endplate 62. In this position, high pressure first fluid 94 enters and pressures the low pressure second fluid 94, driving the second fluid 94 out of the channel 68 and through the aperture 74 for use in the hydraulic fracturing system 10.

In FIG. 6, the channel 68 has rotated through approximately 270 degrees of arc from the position shown in FIG. 3. In this position, the opening 72 is no longer in hydraulic communication with the apertures 78 and 80 of the endplate 64, and the opening 70 is no longer in hydraulic communication with the apertures 74 and 76 of the endplate 62. Accordingly, the high pressure first fluid 94 is no longer pressurized and is temporarily contained within the channel 68 until the rotor 44 rotates another 90 degrees, starting the cycle over again.

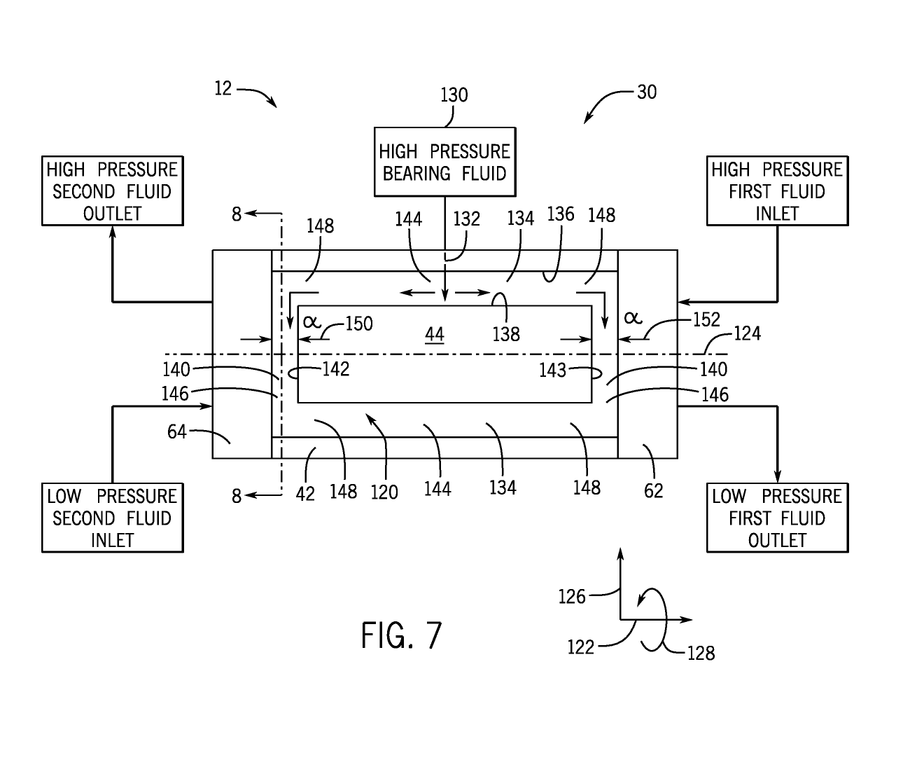

As noted above, the hydraulic energy transfer system 12 (e.g., the rotary IPX 30) may include a fluid bearing system (e.g., a hydrostatic bearing system and/or a hydrodynamic bearing system) configured to facilitate the rotation of rotating components within the hydraulic energy transfer system 12, such as the rotor 44. A hydrostatic bearing system is an externally pressurized fluid bearing. A hydrodynamic bearing system is a fluid bearing that is at least partially pressurized by the rotation of rotating components. For example, FIG. 7 is a schematic diagram of an embodiment of the hydraulic fracturing system 10 that includes the rotary IPX 30 including a fluid bearing system 120. In the following discussion, reference may be made to various directions or axes, such as an axial direction 122 along a rotational axis 124 of the rotor 44, a radial direction 126 away from the axis 124, and a circumferential direction 128 around the axis 124.

Generally, a high pressure bearing fluid 130 may be introduced in proximity to the axial midplane of the rotor 44. The high pressure bearing fluid 130 facilitates radial and axial load bearing of the rotor 44 and in particular, supports the rotor 44 on a fluid film to facilitate rotation of the rotor 44. The high pressure bearing fluid 130 may also help to purge, flush, and/or clean out any debris or particulates from the regions between the rotating components of the rotary IPX 30. The high pressure bearing fluid 130 may be any suitable fluid, such as a proppant-free fluid, a particulate-free fluid, a non-abrasive fluid, water, oil, grease, liquid/powder lubricant mixtures, or a combination thereof. In certain embodiments, the high pressure bearing fluid 130 may be the high pressure first fluid from the first fluid pumps 18. Additionally, the high pressure bearing fluid 130 may be at any suitable pressure. For example, in some embodiments, the high pressure bearing fluid 130 may be at a higher pressure than the low pressure second fluid. In certain embodiments, the high pressure bearing fluid 130 may be at a pressure that is within approximately 50% and 150%, 75% and 125%, 95% and 105%, or any other suitable range, of the high pressure first fluid.

The high pressure bearing fluid 130 may pass through a bearing inlet 132 of the sleeve 42 of the rotary IPX 30 and may enter a plenum region 134 (e.g., chamber). The plenum region 134 includes a radial plenum region 135 (e.g., an annular gap, a radial gap, radial bearing region, or axially extending plenum) between an inner wall 136 (e.g., inner surface) of the sleeve 42 and an outer wall 138 (e.g., an outer radial surface or an outer lateral surface) of the rotor 44. For example, the walls 146 and 138 may be coaxial or concentric annular walls, which have annular surfaces that face one another with an intermediate annular space (e.g., radial clearance or gap circumferentially 128 about the axis 122) defining the plenum region 135. As illustrated, the outer wall 138 extends from a first axial face 142 of the rotor 44 to a second axial face 143 of the rotor 44. The first axial face 142 is disposed proximate to and interfaces with the second endplate 64, and the second axial face 143 is disposed proximate to and interfaces with the first endplate 62. In certain embodiments, the plenum region 134 may also include axial bearing regions 140 (e.g., axial gaps, axial plenum regions, or radially extending plenums) between the first and second axial faces 142 and 143 of the rotor 44 and the respective endplates 62 and 64. In some embodiments, the plenum region 134 may surround (e.g., circumscribe) the outer surfaces of the rotor 44 (e.g., the outer wall 138, the first axial face 142 and the second axial face 143). Thus, the plenum region 134 may be disposed between the outer surfaces of the rotor 44 (e.g., the outer wall 138, the first axial face 142 and the second axial face 143), the inner wall 136 of the sleeve 42, and the endplates 62 and 64. The high pressure bearing fluid 130 may circulate from a high pressure region 144 of the plenum region 134 toward the axial faces 142 of the rotor 44, then toward a lower pressure region 146 of the plenum region 134 in the radial direction 126, thereby facilitating the radial and axial load bearing of the rotor 44. Indeed, as the high pressure bearing fluid 130 circulates from the high pressure region 144 to the lower pressure region 146, it may pass through radial bearing regions 148 between the rotor 44 and the sleeve 42 and the axial bearing regions 140 between the rotor 44 and the endplates 62 and 64.

As illustrated in FIG. 7, the rotor 44 is axially centered within the sleeve 42 and an axial distance 150 (e.g., clearance) between the first axial face 142 and the endplate 64 is equal to an axial distance 152 (e.g., clearance) between the second axial face 143 and the endplate 62. As will be described in more detail below, in certain embodiments, net axial forces may cause the rotor 44 to translate in the axial direction 122 changing the distance 150 and the distance 152, thereby causing one of the axial distances 150 or 152 to be greater than the other.

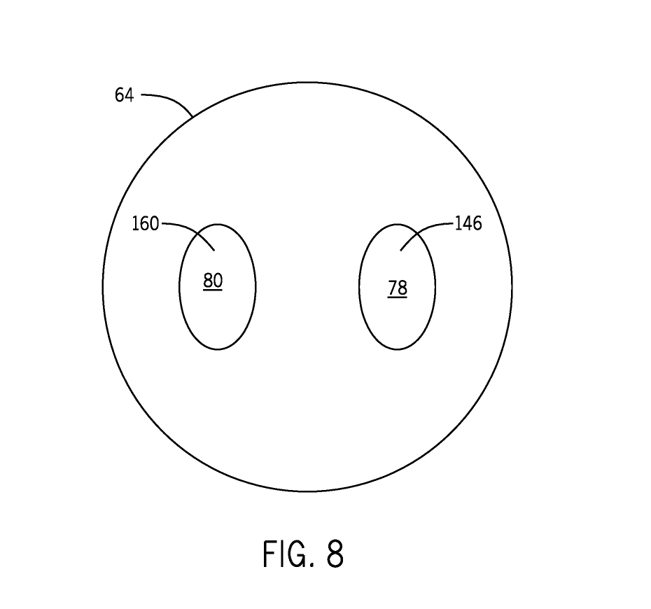

FIG. 8 is a cross-sectional view of the endplate 64 taken along line 8-8 of the rotary IPX 30 of FIG. 7. Specifically, the illustrated embodiment depicts the low pressure region 146, which is disposed proximate to (e.g., surrounds) an opening in the endplate 64 for low pressure fluid to enter (e.g., a low pressure port, a low pressure inlet, or the inlet 78 for the low pressure second fluid). Similarly, the low pressure region 146 of the endplate 62 is disposed proximate to (e.g., surrounds) an opening in the endplate 62 for low pressure fluid to exit (e.g., a low pressure port, a low pressure outlet, or the outlet 76 for the low pressure first fluid). Therefore, the region 146 is at low pressure, and the area about the region 146 is also at a lower pressure due to its hydraulic proximity (e.g., distance) to the region 146. Additionally, the endplate 64 includes a high pressure region 160, which is disposed proximate to (e.g., surrounds) includes an opening in the endplate 64 for high pressure fluid to exit (e.g., a high pressure port, a high pressure outlet, or the outlet 80 for the high pressure second fluid). Similarly, the endplate 62 includes the high pressure region 160, which is disposed proximate to (e.g., surrounds) an opening in the endplate 62 for high pressure fluid to enter (e.g., a high pressure port, a high pressure inlet, or the inlet 80 for the high pressure first fluid inlet). Therefore, the region 160 is at high pressure, and the area about the region 160 is also at a higher pressure due to its hydraulic proximity to the region 160 and to the perimeter of the respective endplate (which is also generally at a higher pressure) The hydraulic proximity may be understood to be the amount of resistance there is to a flow between two points. Indeed, two points that are closer together will generally be in closer hydraulic proximity than two points that are farther apart. Further, two points that are separated by a flow path with a larger hydraulic diameter will be in closer proximity than two points that are separated by a tighter flow path (e.g., the flow path with the larger hydraulic diameter will have less resistance than the flow path with the smaller diameter).

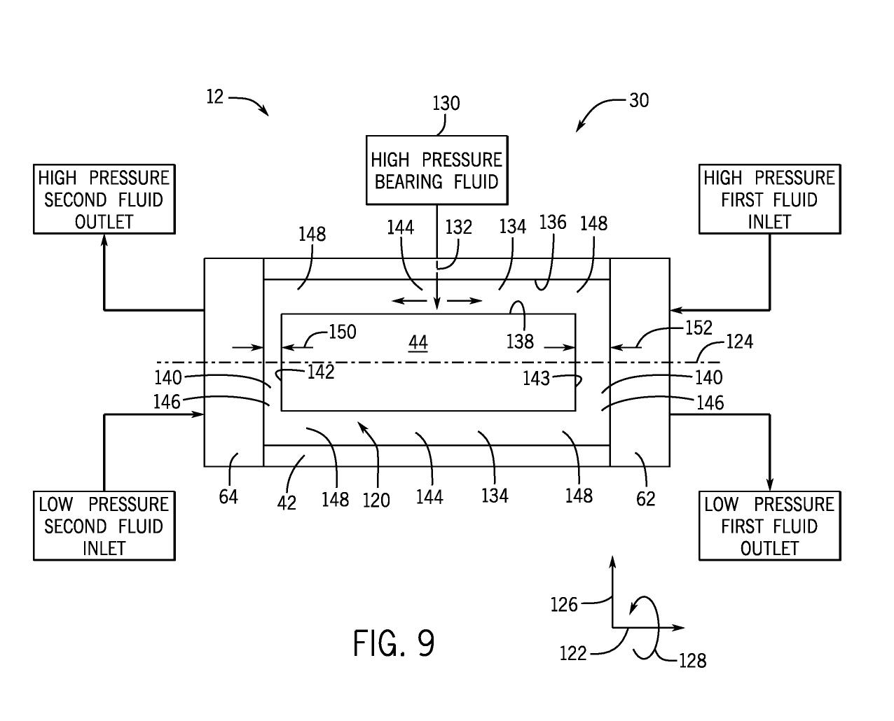

As noted above, net axial forces may act on the rotor 44 (e.g., due to axial face pressure distribution and/or magnitude differences, the weight of the rotor 44, etc.), which may cause the rotor 44 to axially translate. In some embodiments, unbalanced axial forces on the rotor 44 may cause the rotor to axially translate toward the endplate 64. For example, FIG. 9 illustrates an embodiment of the rotary IPX 30 in which the rotor 44 has axially translated and is not axially centered within the sleeve 42. As illustrated, the rotor 44 has translated in the axial direction 122 such that the distance 150 is less than the distance 152. As such, the axial bearing region 140 between the first axial face 142 and the endplate 64 has decreased in both volume and in the axial direction 122, and the axial bearing region 140 between the second axial face 143 and the endplate 62 has increased in both volume and in the axial direction 122. The increase in the axial bearing region 140 between the second axial face 143 and the endplate 62 allows the high pressure bearing fluid 130 to escape (e.g., around the circumference of the second axial face 143), thereby decreasing a net hydrostatic force acting on the second axial face 143 of the rotor 44. Further, the hydrostatic pressure on the second axial face 143 tends to decrease because the clearances to the low pressure first fluid outlet increase while the clearances to high pressure bearing fluid generally remain the same. In particular, the fluid resistance between the points on the second axial face 143 and the low pressure first fluid outlet decreases when the clearance or distance 152 increases (e.g., the hydraulic diameter of the flow path increases) when the rotor 44 axially translates toward the endplate 64. As a result, the points on the second axial face 143 are generally hydraulically closer to the low pressure first fluid outlet (e.g., as compared to when the rotor 44 is axially centered) due to the decreased fluid resistance, but are generally in the same hydraulic proximity to the high pressure bearing fluid. Thus, the high pressure contribution of the bearing fluid has a smaller effect, and the average pressure on the second axial face 143 tends to decrease. The decreased hydrostatic force acting on the second axial face 143 of the rotor 44 tends to decrease the distance 152 of the axial bearing region 140.

Additionally, because the axial bearing region 140 between the first axial face 142 and the endplate 64 has decreased, the high pressure bearing fluid 130 in the axial bearing region 140 between the first axial face 142 and the endplate 64 increases in pressure, which results in a restoring force to resist the decrease in the distance 150. Further, the hydrostatic pressure on the first axial face 142 tends to increase because the clearances to the low pressure second fluid outlet decrease while the clearance to the high pressure bearing fluid generally remain the same. In particular, the fluid resistance between the points on the first axial face 142 and the low pressure second fluid inlet increases when the clearance or distance 150 decreases (e.g., the hydraulic diameter of the flow path decreases) when the rotor 44 axially translates toward the endplate 64. As a result, the points on the first axial face 142 are generally less hydraulically close to the low pressure second fluid inlet (e.g., as compared to when the rotor 44 is axially centered) due to the increased fluid resistance, but are generally in the same hydraulic proximity to the high pressure bearing fluid. Thus, the high pressure contribution of the bearing fluid has a greater effect, and the average pressure on the first axial face 142 tends to increase. In this manner, the hydrostatic bearings work in tandem on both axial faces 142 and 143 to resist axial displacement of the rotor 44 and facilitate steady rotation of the rotor 44.

However, the high pressure first fluid inlet and the high pressure second fluid outlet may reduce the restoring hydrostatic forces on the first and second axial faces 142 and 143. For example, in certain embodiments, in proximity to the high pressure inlet and outlet, the hydrostatic pressure variations resulting from axial displacement of the rotor 44 may be very small because the high pressure bearing fluid, the high pressure first fluid, and the high pressure second fluid are all at high pressure. That is, the modulation of pressures on the first and second axial faces 142 and 143 and the net restoring hydrostatic forces occur due to the variations in the hydraulic proximity of the first and second axial faces 142 and 143 relative to the low pressure second fluid inlet and the low pressure first fluid outlet, respectively. For example, if the endplates 64 and 62 did not include the low pressure second fluid inlet and the low pressure first fluid outlet, respectively, then there would be no changes in the average pressure on the first and second axial faces 142 and 143, even if the rotor 44 is not axially centered. On the other hand, if the endplates 64 and 62 did not include the high pressure second fluid outlet and the high pressure first fluid inlet, respectively, then the pressure distributions on the first and second axial faces 142 and 143 may be entirely determined by the pressure of the bearing fluid and the pressure of low pressure second fluid inlet (for the first axial face 142) or the low pressure first fluid outlet (for the second axial face 143). Thus, while the hydrostatic bearing system 120 may resist axial displacement of the rotor 44, the hydrostatic bearing system 120 may be relatively weak due to the high pressure inlet and outlet.

Accordingly, it may also be desirable to provide features of the hydrostatic bearing system 120 that increase the area on the first and/or second axial faces 142 and 143 over which axial displacement of the rotor 44 results in modulation of the local pressure, which may strengthen the restoring force, stiffen the axial bearing, and increase bearing capacity. For example, in certain scenarios, net axial forces acting on the rotor 44 may cause the rotor 44 to axially translate toward the endplate 64 (e.g., the low pressure second fluid inlet side). Accordingly, it may be desirable to design features of the hydrostatic bearing system 120 that strengthen the restoring force of the hydrostatic bearing system 120 to correct for, counteract, or otherwise offset the net axial forces on the rotor 44, which tend to axially translate the rotor 44 toward the endplate 64, to restore the rotor 44 to a neutral, centered position within the sleeve 42, as illustrated in FIG. 7. In particular, the hydrostatic bearing system 120 may include features that decrease the hydrostatic pressure proximate to the endplate 62 relative to the hydrostatic pressure proximate to the endplate 64, features that increase the hydrostatic pressure proximate to the endplate 64 relative to the hydrostatic pressure proximate to the endplate 62, features that change the average hydraulic pressure of the axial bearing regions, or combinations thereof.

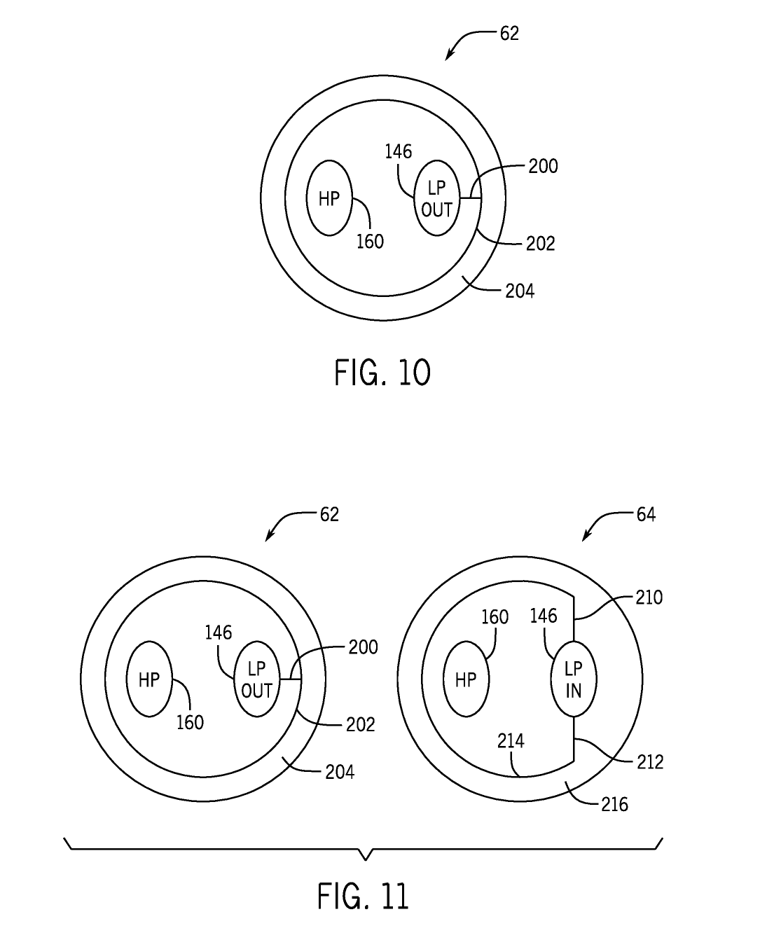

FIG. 10 illustrates an embodiment of the endplate 62 of the rotary IPX 30 having a sink channel 200 (e.g., a radial and/or lateral passage, groove, or recess) and a low pressure sink 202 (e.g., an annular or circumferential passage, groove, or recess). In particular, the sink channel 200 and the low pressure sink 202 may be disposed on (e.g., formed in) an axial face 204 of the endplate 62 that faces (e.g., disposed adjacent to, interfaces with) the second axial face 143 of the rotor 44. Additionally, the endplate 62 includes the low pressure region 146 and the high pressure region 160, as described in detail above with respect to FIG. 8. The sink channel 200 may extend from the low pressure region 146 (e.g., the low pressure first fluid outlet 74) in the radial direction 126 relative to the rotational axis 124. The sink channel 200 hydraulically couples the low pressure region 146 to the low pressure sink 202. For example, the sink channel 200 may route low pressure fluid (e.g., low pressure first fluid) from the low pressure region 146 (e.g., from the low pressure first fluid outlet 74) to the low pressure sink 202. The low pressure sink 202 effectively decreases the hydraulic distance for a region of the axial face 143 in proximity to the low pressure sink 202, reducing the pressure accordingly.

By providing the low pressure sink 202 on the endplate 62 and not providing a low pressure sink on the endplate 64, the hydrostatic pressure proximate to the endplate 62 and the second axial face 143 may decrease while the hydrostatic pressure proximate to the endplate 64 and the first axial face 142 remains unchanged. As such, the hydrostatic pressure on the second axial face 143 may be reduced, while the hydrostatic pressure on the first axial face 143 may remain unchanged. This may change, counteract, or otherwise offset the net axial forces acting on the rotor 44 to reduce, resist, or avoid axial displacement of the rotor 44 toward the endplate 64. Further, the features of the hydraulic bearing system 120, such as the low pressure sink 202, may change the average hydraulic pressure of the axial bearing region 140 proximate to the endplate 66 as compared to a hydraulic bearing system 120 without the low pressure sink 202. Indeed, the average hydraulic pressure of the axial bearing region 140 about the endplate 62 may be selected to correct for, counteract, or otherwise offset the net axial forces acting on the rotor 44, such as the weight of the rotor 44, net dynamic hydraulic pressures, net static hydraulic pressures, etc, to maintain a position of the rotor 44 within the sleeve 42 such that the rotor 44 does not contact the endplates 62 and 64, which may cause the rotor 44 to stall. Further, the sink channel 200 and the low pressure sink 202 on the endplate 62 may reduce the average hydraulic pressure of the axial bearing region 140 about the endplate 62 to reduce, resist, or avoid axial displacement of the rotor 44.

As illustrated, the sink channel 200 connects the low pressure sink 202 to the low pressure region 146. However, it should be appreciated that any number of sink channels 200 (e.g., 1, 2, 3, 4, 5, 6, 7, 8, or more) may be provided in any suitable location. The one or more sink channels 200 may be formed via a groove (e.g., recess) in the axial face 204 of the endplate 62, such that it connects the low pressure sink 202 to the low pressure region 146 (e.g., the low pressure first fluid outlet 74). In certain embodiments, the high pressure bearing fluid 130 may be configured to travel from the high pressure region 160 to the low pressure region 146 in the radial direction, as well as to the low pressure sink 202. As such, the low pressure sink 202 may decrease the hydraulic pressure in an area in proximity to the low pressure sink 202 by decreasing the hydraulic proximity (e.g., the hydraulic distance) to the low pressure region 146. Similarly, a sink channel may connect a high pressure sink to the high pressure region (e.g., the high pressure first fluid inlet or the high pressure second fluid outlet) to increase the pressure in regions proximate to the high pressure sink.

As illustrated, the low pressure sink 202 is provided as a loop (e.g., an annular or circumferential groove, passage, recess, etc. in the endplate 62) about the perimeter of the endplate 62 (e.g., a 360 degree loop). For example, in some embodiments, the low pressure sink 202 may fully extend circumferentially about the rotational axis 124 of the rotor 44. It should be appreciated that in other embodiments, the low pressure sink 202 may be provided as a partial loop connected to the low pressure region 146 via the one or more sink channels 200 (e.g., may partially extend circumferentially 128 about the rotational axis 124). For example, the low pressure sink 202 may be provided as a partial loop spanning approximately 1 degree to 360 degrees, 25 degrees to 325 degrees, 50 degrees to 300 degrees, 75 degrees to 275 degrees, 100 degrees to 250 degrees, 125 degrees to 225 degrees, 150 degrees to 200 degrees, or any other suitable range about the rotational axis 124. In certain embodiments, the low pressure sink 202 may partially or completely surround (e.g., circumscribe) the high pressure region 160 (e.g., the high pressure port). Further, it should be noted that the one or more sink channels 200 may include any suitable length, width, and depth, and in embodiments in which two or more sink channels 200 are incorporated, the length, width, and depth of the two or more sink channels 200 may be the same as or may vary relative to one another. Additionally, the width and/or depth of the low pressure sink 200 may be uniform or may vary along the low pressure sink 200.

Additionally, in some embodiments, both the endplate 62 and the endplate 64 may include a low pressure sink. However, the low pressure sink of the endplate 62 may include different features from the low pressure sink of the endplate 64 to create a pressure differential between the hydrostatic pressure proximate to the endplate 62 and the hydrostatic pressure proximate to the endplate 64. In particular, the low pressure sinks of the endplate 62 and the endplate 64 may vary, such that the resulting pressure differential corrects for, counteracts, adjusts, and/or balances the net axial forces acting on the rotor 44 to reduce, resist, or avoid axial displacement of the rotor 44.

For example, FIG. 11 illustrates an embodiment of the endplate 62 having the one or more sink channels 200 (e.g., radial groove or passage) and the low pressure sink 202 (e.g., an annular or circumferential loop, passage, or groove) and an embodiment of the endplate 64 having a first sink channel 210 (e.g., a radial and/or lateral groove or passage), a second sink channel 212 (e.g., a radial and/or lateral groove or passage), and a partial low pressure sink 214 (e.g., a semi-circular loop, passage, or groove). In particular, the first sink channel 210 and the second sink channel 212 extend from the low pressure region 146 of the endplate 64 (e.g., the low pressure first fluid outlet 80) the radial direction 126 relative to the rotation axis 124 of the rotor 44. Additionally, the first and sink channels 210 and 212 hydraulically couple the partial low pressure sink 210 to the low pressure region 146 (e.g., the low pressure first fluid outlet 80). For example, the first and second sink channels 210 and 212 may route low pressure fluid (e.g., low pressure first fluid) from the low pressure region 146 (e.g., the low pressure first fluid outlet 80) to the partial low pressure sink 214. The partial low pressure sink 214 may be smaller than the low pressure sink 202. That is, the partial low pressure sink 214 may cover a first surface area of an axial face 216 of the endplate 64, and the low pressure sink 200 may cover a second surface area of the axial face 204 of the end plate 62 that is greater than the first surface area. For example, the second surface area may be between approximately 5% and 90%, 10% and 80%, 20% and 70%, 30% and 50% greater than the first surface area. By providing the low pressure sink 202 on the endplate 62 and providing the partial low pressure sink 214 on the endplate 64, the hydrostatic pressure proximate to the endplate 62 and the second axial face 143 may decrease relative to the hydrostatic pressure proximate to the endplate 64 and the first axial face 142. As such, the resulting pressure differential may correct for, counteract, adjust, and/or balance the net axial forces acting on the rotor 44 to reduce, resist, or avoid axial displacement of the rotor 44 toward the endplate 64.

The first and second sink channels 210 and 212 and the partial low pressure sink 214 may be disposed on (e.g., formed in) the axial face 216 of the endplate 64 that faces (e.g., is disposed adjacent to, interfaces with) the first axial face 142 of the rotor 44. Additionally, the endplate 64 includes the low pressure region 146 and the high pressure region 160, as described in detail above with respect to FIG. 8. While the illustrated embodiment depicts two sink channels 210 and 212, it should be appreciated that any number of sink channels (e.g., 3, 4, 5, 6, 7, 8, or more) may be provided in any suitable location. The first and second sink channels 210 and 212 may be formed via grooves (e.g., recesses) in the axial face 216 of the endplate 64, such that they connect the partial low pressure sink 214 to the low pressure region 146. Further, in some embodiments, the first and second sink channels 210 and 212 may be configured to act as a drain that routes the high pressure bearing fluid 130 out of the low pressure region 146 of the rotary IPX 30. Accordingly, in certain embodiments, the high pressure bearing fluid 130 may be configured to travel from the high pressure region 160 to the low pressure region 146 in the radial direction 126, as well as to the low pressure sink 214. As such, a low pressure fluid is provided proximal to the low pressure region 146 via the low pressure sink 214, thereby improving the hydrostatic bearing performance within the low pressure region 146 and throughout the rotary IPX 30.

As illustrated, the partial low pressure sink 214 is provided as a partial loop about the perimeter of the endplate 64 (e.g., a loop less than 360 degrees). In particular, the partial low pressure sink 214 starts and ends at the low pressure region 146. The partial low pressure sink 214 may partially extend about the rotational axis 124 of the rotor 44. The partial low pressure sink 214 may be provided as a partial loop spanning approximately 1 degree to 360 degrees, 25 degrees to 325 degrees, 50 degrees to 300 degrees, 75 degrees to 275 degrees, 100 degrees to 250 degrees, 125 degrees to 225 degrees, 150 degrees to 200 degrees, or any other suitable range about the rotation axis 124. Additionally, the length and/or the volume of the partial low pressure sink 214 may be approximately 1% to 90%, 5% to 80%, 10% to 70%, 15% to 60%, 20% to 50%, or 30% to 40% less than the respective length and/or volume of the low pressure sink 202. Further, it should be noted that the first and second sink channels 210 and 212 may include any suitable length, width, and depth, and in some embodiments, the length, width, and depth of the first and second sink channels 210 and 212 may vary.

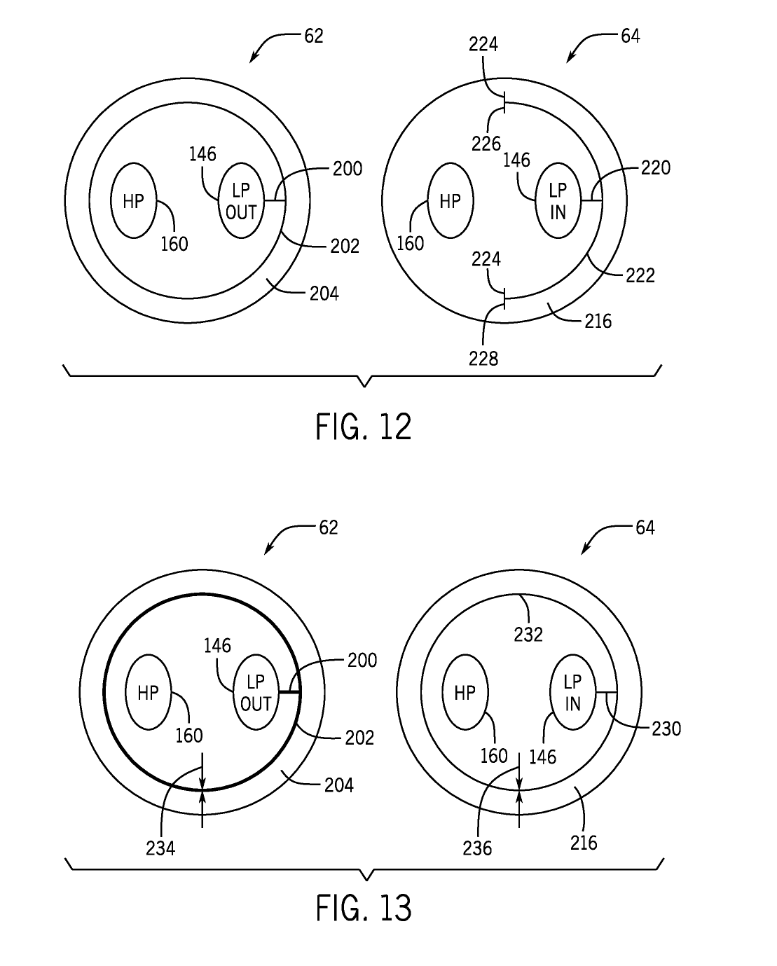

FIG. 12 illustrates an embodiment of the endplate 62 having the one or more sink channels 200 and the low pressure sink 202 and an embodiment of the endplate 64 having one more sink channels 220, a partial low pressure sink 222 (e.g., an arcuate or curved groove or passage), and one or more sink endpoints 224. As noted above with respect to FIG. 11, the partial low pressure sink 222 may be smaller than the low pressure sink 202, such that the hydrostatic pressure proximate to the endplate 62 may decrease relative to the hydrostatic pressure proximate to the endplate 64. For example, the length and/or the volume of the partial low pressure sink 222 may be approximately 1% to 90%, 5% to 80%, 10% to 70%, 15% to 60%, 20% to 50%, or 30% to 40% less than the respective length and/or volume of the low pressure sink 202. The one or more sink endpoints 224 are configured as a stop point for the partial low pressure sink 222, which may include one or more prongs that extend from the low sink channel 220 to a respective endpoint 224. For example, in the illustrated embodiment, the low partial low pressure sink 222 begins at the low pressure region 146 and includes a first sink endpoint 226 and a second sink endpoint 228 that terminates the prongs of the partial low pressure sink 222 before it extends across the perimeter of the endplate 64. By providing the low pressure sink 202 on the endplate 62 and providing the partial low pressure sink 222 on the endplate 64, the hydrostatic pressure proximate to the endplate 62 and the second axial face 143 may decrease relative to the hydrostatic pressure proximate to the endplate 64 and the first axial face 142. As such, the resulting pressure differential may correct for, counteract, adjust, and/or balance the net axial forces acting on the rotor 44 to reduce, resist, or avoid axial displacement of the rotor 44 toward the endplate 64.

FIG. 13 illustrates an embodiment of the endplate 62 having the one or more sink channels 200 (e.g., radial groove or passage) and the low pressure sink 202 (e.g., annular or circumferential loop, groove, or passage) and an embodiment of the endplate 64 having a sink channel 230 (e.g., radial groove or passage) and a low pressure sink 232 (e.g., annular or circumferential loop, groove, or passage). As illustrated, the low pressure sink 202 may include a width 234 that is greater than a width 236 of the low pressure sink 232. As such, the low pressure sink 202 may have a cross-sectional area and/or volume that is greater than the cross-sectional area and/or volume of the low pressure sink 232. For example, the low pressure sink 202 may cover a first surface area of the axial surface 204, and the low pressure sink 232 may cover a second surface area of the axial surface 216 that is less than the first surface area. In some embodiments, the low pressure sink 202 may additionally or alternatively include a depth that is greater than a depth of the low pressure sink 232. Further, in certain embodiments, the sink channel 230 may be configured to extend from the low pressure region 146 toward the high pressure region 160 and the sink channel 200 may extend from the low pressure region 146 away from the high pressure region 160 to decrease the surface area of the low pressure sink 230 relative to the low pressure sink 202. As such, the low pressure sink 232 may be smaller (e.g., covers a smaller surface area) than the low pressure sink 202, which may decrease the hydrostatic pressure proximate to the endplate 62 relative to the hydrostatic pressure proximate to the endplate 64. As such, the resulting pressure differential may correct for, counteract, or otherwise offset the net axial forces acting on the rotor 44 to reduce, resist, or avoid axial displacement of the rotor 44. Further, the low pressure sink 202 with the greater width 234 may decrease the hydraulic distance between the low pressure sink 202 and the low pressure region 146 (e.g., as compared to a low pressure sink in the same location with a smaller width), which may decrease the average hydraulic pressure of the endplate 62. Additionally, the hydraulic distance between the low pressure sink 232 and the low pressure region 146 of the endplate 64 may be different than the low pressure sink 202 and the low pressure region 146 of the endplate 62 due to the difference in the widths 234 and 236. It should be appreciated that any combination of depth, width, length, and/or surface area (e.g., width and length) for the low pressure sinks on each end plate 62 and 64 may be used to create a volume for each low pressure sink, which may be different between the two low pressure sinks.

It should be noted that the perimeter of the low pressure sink 202, the perimeter of the partial low pressure sink 214, the perimeter of the partial low pressure sink 222, and the perimeter of the low pressure sink 232 may be determined and optimized based on the magnitude of bearing capacity desired and the magnitude of the hydrostatic pressure differential between the axial bearing region 140 proximate to the endplate 62 and the axial bearing region 140 proximate to the endplate 64. For example, based on the amount of bearing capacity or hydrostatic pressure differential desired from the hydrostatic bearing system 120, the perimeter and the number of sink channels for each low pressure sink may be determined. Having greater sink capacity will tend to increase leakage (e.g., fluid communication or mixing between the first fluid and the second fluid flowing through the endplate) which is undesirable, so there may be a tradeoff involved. Further, the location, the total length (e.g., 360 degree loop or a partial loop), the width, and/or the depth of the low pressure sinks of the endplate 62 and the endplate 64 may be determined based on a desired pressure differential between the axial bearing region 140 proximate to the endplate 62 and the axial bearing region 140 proximate to the endplate 64. Additionally, in other embodiments, the endplate 64 may include one or more high pressure sinks to increase the hydrostatic pressure in the axial bearing region 140 proximate to the endplate 64 relative to the hydrostatic pressure in the axial bearing region 140 proximate to the endplate 62.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a rotary isobaric pressure exchanger (IPX) comprising:
a rotor comprising a first axial end face and a second axial end face; and
a first endplate comprising:
a first axial surface disposed adjacent to the first axial end face of the rotor;
a first low pressure fluid port;
a first high pressure fluid port;
a first channel formed in the first axial surface and extending from the first low pressure fluid port; and
a first low pressure sink formed in the first axial surface and extending from the first channel, wherein the first channel is configured to route low pressure fluid from the first low pressure fluid port to the first low pressure sink.

2. The system of claim 1, wherein the first low pressure sink extends from the first channel in a circumferential direction relative to a rotational axis of the rotor.

3. The system of claim 2, wherein the first low pressure sink comprises an annular loop that circumscribes the first high pressure fluid port.

4. The system of claim 1, wherein the first low pressure sink extends toward the first high pressure port.

5. The system of claim 4, wherein the first channel extends away from the first high pressure port.

6. The system of claim 5, wherein the first low pressure sink circumscribes the first low pressure fluid port and the first high pressure fluid port.

7. The system of claim 1, wherein the first endplate comprises a second channel formed in the first axial surface and extending from the first low pressure fluid port, the first low pressure sink extends between the first channel and the second channel, and the second channel is configured to route low pressure fluid from the first low pressure fluid port to the first low pressure sink.

8. The system of claim 1, wherein the rotor comprises a second endplate comprising:
a second axial surface disposed adjacent to the second axial end face of the rotor;
a second low pressure fluid port;
a second high pressure fluid port;
a second channel formed in the second axial surface and extending from the second low pressure fluid port; and
a second low pressure sink formed in the second axial surface and extending from the second channel, wherein the second channel is configured to route low pressure fluid from the second low pressure fluid port to the second low pressure sink; and
wherein the first channel and the first low pressure sink cover a first volume of the first axial surface of the first endplate, the second channel and the second low pressure sink cover a second volume of the second axial surface of the second endplate, and the first volume is greater than the second volume.

9. The system of claim 8, wherein the first low pressure fluid port is configured to output a first fluid at low pressure, the first high pressure fluid port is configured to receive the first fluid at high pressure, the second low pressure fluid port is configured to receive a second fluid at low pressure, and the second high pressure fluid port is configured to output the second fluid at high pressure.

10. A system, comprising:
a rotary isobaric pressure exchanger (IPX) configured to exchange pressure between a first fluid and a second fluid, wherein the rotary IPX comprises:
a rotor comprising a first axial end face and a second axial end face;
a first endplate comprising a first axial surface disposed adjacent to the first axial end face of the rotor;
a high pressure inlet formed in the first endplate and configured to receive the first fluid at high pressure;
a low pressure outlet formed in the first endplate and configured to output the first fluid at low pressure;
a first channel formed in the first axial surface and extending from the low pressure outlet; and
a first low pressure sink formed in the first axial surface and extending from the first channel, wherein the first channel is configured to route the first fluid at low pressure from the low pressure outlet to the first low pressure sink.

11. The system of claim 10, wherein the rotary IPX comprises:
a second endplate comprising a second axial surface disposed adjacent to the second axial end face of the rotor;
a low pressure inlet formed in the second endplate and configured to receive the second fluid at low pressure; and
a high pressure outlet formed in the second endplate and configured to output the second fluid at high pressure.

12. The system of claim 11, wherein the first channel and the first low pressure sink reduce an average hydrostatic pressure on the first axial end face of the rotor to resist axial displacement of the rotor toward the second endplate.

13. The system of claim 12, wherein the second endplate does not include a low pressure sink.

14. The system of claim 11, wherein the rotary IPX comprises:
a second channel formed in the second axial surface and extending from the low pressure inlet; and
a second low pressure sink formed in the second axial surface and extending from the second channel, wherein the second channel is configured to route the second fluid at low pressure from the low pressure inlet to the second low pressure sink;
wherein the first channel and the first low pressure sink cover a first volume of the first axial surface, the second channel and the second low pressure sink cover a second volume of the second axial surface, and the first volume is greater than the second volume.

15. The system of claim 14, wherein a first length of the first low pressure sink is greater than a second length of the second low pressure sink, a first width of the first low pressure sink is greater than a second width of the second low pressure sink, a first depth of the first low pressure sink is greater than a second depth of the second low pressure sink, or a combination thereof.

16. The system of claim 14, wherein the first low pressure sink and the second low pressure sink extend circumferentially about a rotational axis of the rotor, the first low pressure sink comprises an annular loop, and the second low pressure sink comprises a partial loop or an arcuate curve.

17. A rotary isobaric pressure exchanger (IPX) configured to exchange pressure between a first fluid and a second fluid, wherein the rotary IPX comprises:
a rotor comprising a first axial end face and a second axial end face;
a first endplate comprising a first axial surface disposed adjacent to the first axial end face of the rotor;
a high pressure inlet formed in the first endplate and configured to receive the first fluid at high pressure;
a low pressure outlet formed in the first endplate and configured to output the first fluid at low pressure;
a second endplate comprising a second axial surface disposed adjacent to the second axial end face of the rotor;
a low pressure inlet formed in the second endplate and configured to receive the second fluid at low pressure;
a high pressure inlet formed in the second endplate and configured to output the second fluid at high pressure;
a first channel formed in the first axial surface and extending from the low pressure outlet; and
a first low pressure sink formed in the first axial surface and extending from the first channel, wherein the first channel is configured to route the first fluid at low pressure from the low pressure outlet to the first low pressure sink, and the first channel and the first low pressure sink are configured to reduce a hydrostatic pressure proximate to the first axial end face of the rotor to resist axial displacement of the rotor toward the second endplate.

18. The system of claim 17, wherein the second endplate does not include a low pressure sink.

19. The system of claim 17, comprising:
a second channel formed in the second axial surface and extending from the low pressure inlet; and
a second low pressure sink formed in the second axial surface and extending from the second channel, wherein the second channel is configured to route the second fluid at low pressure from the low pressure inlet to the second low pressure sink;
wherein the first channel and the first low pressure sink cover a first volume of the first axial surface, the second channel and the second low pressure sink cover a second volume of the second axial surface, and the first volume is greater than the second volume.

20. The system of claim 19, wherein a first length of the first low pressure sink is greater than a second length of the second low pressure sink, a first width of the first low pressure sink is greater than a second width of the second low pressure sink, a first depth of the first low pressure sink is greater than a second depth of the second low pressure sink, or a combination thereof.
